(19) United States
(12) Patent Application Publication
(10) Pub. No.: US 2024/0420505 A1
(43) Pub. Date: Dec. 19, 2024

(54) IRIS RECOGNITION APPARATUS, IRIS RECOGNITION SYSTEM, IRIS RECOGNITION METHOD, AND RECORDING MEDIUM

(71) Applicants: NEC CORPORATION, Tokyo (JP); THE UNIVERSITY OF ELECTRO-COMMUNICATIONS, Chofu-shi, Tokyo (JP)

(72) Inventors: Takahiro TOIZUMI, Tokyo (JP); Masato TSUKADA, Tokyo (JP); Yuka OGINO, Tokyo (JP); Masatsugu ICHINO, Tokyo (JP); Tsubasa BOURA, Tokyo (JP)

(73) Assignees: NEC CORPORATION, Tokyo (JP); THE UNIVERSITY OF ELECTRO-COMMUNICATIONS, Chofu-shi, Tokyo (JP)

(21) Appl. No.: 18/705,213

(22) PCT Filed: Oct. 29, 2021
(86) PCT No.: PCT/JP2021/040123

§ 371 Date: Apr. 26, 2024

(51) Int. Cl. G06V 40/18; G06T 3/4053; G06V 10/52; G06V 10/77; G06V 10/82

(52) U.S. Cl. CPC G06V 40/193; G06T 3/4053; G06V 10/52; G06V 10/7715; G06V 40/197; G06V 10/82

(57) ABSTRACT

Included are: an iris image acquisition unit that acquires an iris image including an iris of a living body; a calculation unit that calculates a scale factor for the iris image, from a size of an iris area included in the iris image and from a desired size; a generation unit that generates a resolution-converted image in which resolution of the iris image is converted in accordance with the scale factor; and a post-transform feature vector extraction unit that extracts a post-transform feature vector that is a feature vector of the resolution-converted image.

### TECHNICAL FIELD

This disclosure relates to technical fields of an iris recognition apparatus, an iris recognition system, an iris recognition method, and a recording medium.

### BACKGROUND ART

Non-Patent Literature 1 describes a technique/technology for performing super-resolution of an image such that much information for matching is provided by machine learning using a loss function for matching. Furthermore, Non-Patent Literature 2 describes a technique/technology for performing super-resolution corresponding to various magnification in a single network, by estimating a filter corresponding to the magnification of up-sampling.

### CITATION LIST

### Patent Literature

Non-Patent Literature 1: Maneet Singh, Shruti Nagpal, Mayank Vatsa, Richa Singh, Angshul Majumdar; Proceedings of the IEEE Conference on Computer Vision and Pattern Recognition (CVPR) Workshops, 2018, pp. 479-488.
Non-Patent Literature 2: Xuecai Hu, Haoyuan Mu, Xiangyu Zhang, Zilei Wang, Tieniu Tan, Jian Sun; Proceedings of the IEEE/CVF Conference on Computer Vision and Pattern Recognition (CVPR), 2019, pp. 1575-1584.

### SUMMARY

### Technical Problem

It is an example object of this disclosure to provide an iris recognition apparatus, an iris recognition system, an iris recognition method, and a recording medium that are intended to improve the techniques/technologies described in Citation List.

### Solution to Problem

An iris recognition apparatus according to an example aspect of this disclosure includes: an iris image acquisition unit that acquires an iris image including an iris of a living body; calculation unit that calculates a scale factor for the iris image, from a size of an iris area included in the iris image and from a desired size; a generation unit that generates a resolution-converted image in which resolution of the iris image is converted in accordance with the scale factor; and a post-transform feature vector extraction unit that extracts a post-transform feature vector that is a feature vector of the resolution-converted image.

An iris recognition system according to an example aspect of this disclosure includes: an iris image acquisition unit that acquires an iris image including an iris of a living body; a calculation unit that calculates a scale factor for the iris image, from a size of an iris area included in the iris image and from a desired size; a generation unit that generates a resolution-converted image in which resolution of the iris image is converted in accordance with the scale factor; and a post-transform feature vector extraction unit that extracts a post-transform feature vector that is a feature vector of the resolution-converted image.

An iris recognition method according to an example aspect of this disclosure includes: acquiring an iris image including an iris of a living body; calculating a scale factor for the iris image, from a size of an iris area included in the iris image and from a desired size; generating a resolution-converted image in which resolution of the iris image is converted in accordance with the scale factor; and extracting a post-transform feature vector that is a feature vector of the resolution-converted image.

A recording medium according to an example aspect of this disclosure is a recording medium on which a computer program that allows a computer to execute an iris recognition method is recorded, the iris recognition method including: acquiring an iris image including an iris of a living body; calculating a scale factor for the iris image, from a size of an iris area included in the iris image and from a desired size; generating a resolution-converted image in which resolution of the iris image is converted in accordance with the scale factor; and extracting a post-transform feature vector that is a feature vector of the resolution-converted image.

### BRIEF DESCRIPTION OF DRAWINGS

FIG. 1 is a block diagram illustrating a configuration of an iris recognition apparatus in a first example embodiment.

FIG. 2 is a block diagram illustrating the configuration of an iris recognition apparatus in a second example embodiment.

FIG. 3 is a flowchart illustrating a flow of an iris recognition operation performed by the iris recognition apparatus in the second example embodiment.

FIG. 4 is a block diagram illustrating a configuration of an iris recognition apparatus in a third example embodiment.

FIG. 5 is a flowchart illustrating a flow of a learning operation performed by the iris recognition apparatus in the third example embodiment.

FIG. 6 is a block diagram illustrating a configuration of an iris recognition apparatus in a fifth example embodiment.

FIG. 7 is a flowchart illustrating a flow of a super-resolution processing performed by the iris recognition apparatus in the fifth example embodiment.

FIG. 8 is a block diagram illustrating a configuration of an iris recognition apparatus in a sixth example embodiment.

FIG. 9 is a flowchart illustrating a flow of a super-resolution processing performed by the iris recognition apparatus in the sixth example embodiment.

FIG. 10 is a block diagram illustrating a configuration of an iris recognition apparatus in a seventh example embodiment.

FIG. 11 is a flowchart illustrating a flow of a super-resolution processing performed by the iris recognition apparatus in the seventh example embodiment.

FIG. 12 is a block diagram illustrating a configuration of an iris recognition apparatus in an eighth example embodiment.

FIG. 13 is a flowchart illustrating a flow of an iris recognition operation performed by the iris recognition apparatus in the eighth example embodiment.

FIG. 14 is a block diagram illustrating a configuration of an iris recognition device in a ninth example embodiment.

### DESCRIPTION OF EXAMPLE EMBODIMENTS

Hereinafter, with reference to the drawings, an iris recognition apparatus, an iris recognition system, an iris recognition method, and a recording medium according to example embodiments will be described with reference to the drawings.

### 1: First Example Embodiment

First, an iris recognition apparatus, an iris recognition method, and a recording medium according to a first example embodiment will be described. The following describes the iris recognition apparatus, the iris recognition method, and the recording medium according to the first example embodiment, by using an iris recognition apparatus 1 to which the iris recognition apparatus, the iris recognition method, and the recording medium according to the first example embodiment are applied.

### 1-1: Configuration of Iris Recognition Apparatus 1

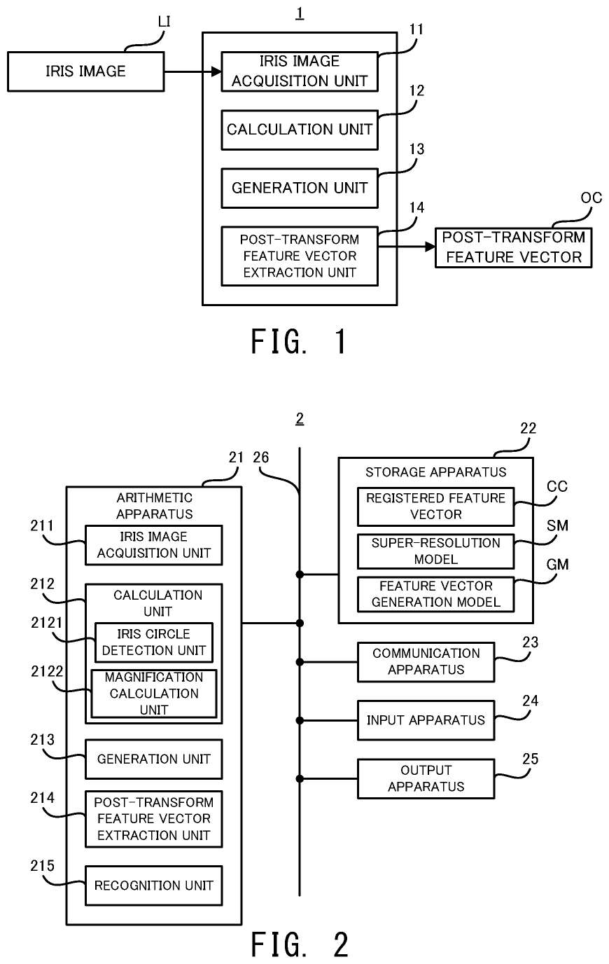

FIG. 1 is a block diagram illustrating a configuration of the iris recognition apparatus 1 in the first example embodiment. As illustrated in FIG. 1, the iris recognition apparatus 1 includes an iris image acquisition unit 11, a calculation unit 12, a generation unit 13, and a post-transform feature vector extraction unit 14.

The iris image acquisition unit 11 acquires an iris image LI including an iris of a living body. The iris refers to a part of an annulus shape around a pupil that lies inside the dark part of the eye. The iris has a unique pattern for each individual. Furthermore, the iris is a part suitable for biometric recognition because it is covered by a cornea and is thus hardly damaged.

The calculation unit 12 calculates a scale factor for the iris image LI, from a size of an iris area included in the iris image LI and a desired size. The size of the iris area included in the iris image LI may be expressed, for example, as the number of pixels of the iris area in the iris image, a diameter of the iris area in the iris image, and an area of the iris area in the iris image. Described hereinafter is a case where the size of the iris area included in the iris image LI is expressed as the number of pixels of the iris area in the iris image.

In iris recognition, recognition using an iris pattern is performed. For this reason, the iris recognition needs to use an image including an iris area with an appropriate number of pixels for the iris recognition. A desired number of pixels may be an appropriate number of pixels for the iris recognition. Since the iris is substantially circular, the number of pixels may be expressed as a radium of the relevant area. The substantially circular iris area is also referred to as an iris circle. The number of pixels may correspond to resolution. For example, the desired number of pixels may be 100 pixels or more, or may be 100 pixels, 125 pixels, or the like.

Generally, the iris recognition preferably uses a relatively high-resolution iris image HI. In contrast, iris detection may be performed by using a low-resolution iris image LI since it detects edges of the iris area and a pupil area. Information about the number of pixels, position of a pupil circle and the iris circle, or the like, which is acquired by the iris detection, may be used for a super-resolution processing of enhancing the resolution of the low-resolution iris image LI. Here, the super-resolution processing indicates a processing that enhances the resolution of a low-resolution image to generate a high-resolution image, and that is capable of generating a relatively high-quantity, high-resolution image.

For example, the calculation unit 12 may acquire a ratio between a radius of the iris circle detected and a radius of an area with the desired number of pixels, thereby to calculate the scale factor. That is, the calculation unit 12 may calculate the scale factor on the basis of the information acquired by the iris detection. The scale factor is not limited to 1 or more, and may be less than 1. For example, in a case where a desired radius is 50 pixels and a radius of the iris circle included in the iris image LI includes 25 pixels, the calculation unit 12 may calculate the scale factor to be 2. Furthermore, in a case where the desired radius is 50 pixels and the radius of the iris circle is 100 pixels, the calculation unit 12 may calculate the scale factor to be 0.5.

The generation unit 13 generates a resolution-converted image RI in which the resolution of the iris image LI is converted in accordance with the scale factor. For example, in a case where the scale factor calculated by the calculation unit 12 from the radius of the iris circle is 2, the generation unit 13 may generate the resolution-converted image RI in which the resolution of the iris image LI is doubled.

The post-transform feature vector extraction unit 14 extracts a post-transform feature vector OC that is a feature vector of the resolution-converted image RI. The post-transform feature vector extraction unit 14 may be configured to extract the feature vector from an image with the desired number of pixels. In the post-transform feature vector extraction unit 14, the calculation unit 12 calculates the scale factor so as to extract the feature vector properly, and the generation unit 13 may generate the resolution-converted image RI in accordance with the scale factor.

The feature vector here is a vector representing features of the iris required to perform the iris recognition. The vector here may include a scalar value, an array, or an array with two or more dimensions. The post-transform feature vector extraction unit 14 may be configured by a convolution neural network, for example.

### 1-2: Technical Effect of Iris Recognition Apparatus 1

The iris recognition apparatus 1 in the first example embodiment is allowed to convert the iris image LI to an image with the desired number of pixels, regardless of the number of pixels of the iris image LI. The iris recognition apparatus 1 in the first example embodiment is allowed to perform the super-resolution processing of enhancing the resolution of the low-resolution iris image LI, thereby to acquire the high-resolution iris image HI. The resolution of the iris image LI on which the iris recognition apparatus 1 in the first example embodiment performs the super-resolution processing, may be any resolution, and is not limited to a particular resolution. The iris recognition apparatus 1 in the first example embodiment is allowed to perform the iris recognition by using the iris images LI of various resolutions.

In the iris recognition apparatus 1 in the first example embodiment, in order that the feature vector can be properly extracted in the post-transform feature vector extraction unit 14, the calculation unit 12 calculates the scale factor, and the generation unit 13 generates the resolution-converted image RI in accordance with the scale factor. That is, it is not necessary to change a mechanism for the iris recognition in the iris recognition apparatus 1 in the first example embodiment. Therefore, the iris recognition apparatus 1 in the first example embodiment can be applied to mechanism that is configured to perform the iris recognition using the iris image HI with the desired number of pixels.

### 2: Second Example Embodiment

Next, an iris recognition apparatus, an iris recognition method, and a recording medium according to a second example embodiment will be described. The following describes the iris recognition apparatus, the iris recognition method, and the recording medium according to the second example embodiment, by using an iris recognition apparatus 2 to which the iris recognition apparatus, the iris recognition method, and the recording medium according to the second example embodiment are applied.

### 2-1: Configuration of Iris Recognition Apparatus 2

First, with reference to FIG. 2, a configuration of the iris recognition apparatus 2 in the second example embodiment will be described. FIG. 2 is a block diagram illustrating the configuration of the iris recognition apparatus 2 in the second example embodiment. In the following description, the components already described carry the same reference numerals, and a detailed description thereof will be omitted.

As illustrated in FIG. 2, the iris recognition apparatus 2 includes an arithmetic apparatus and a storage apparatus 22. Furthermore, the iris recognition apparatus 2 may include a communication apparatus 23, an input apparatus 24, and an output apparatus 25. The iris recognition apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus may be connected through a data bus 26.

The arithmetic apparatus 21 includes, for example, at least one of a CPU (Central Processing Unit), a GPU (Graphics Processing Unit), and a FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the iris recognition apparatus 2 (e.g., the input apparatus 24, described later). The arithmetic apparatus 21 may acquire (i.e., download or read) a computer program from a not-illustrated apparatus disposed outside the iris recognition apparatus 2, through the communication apparatus 23 (or another communication apparatus). The arithmetic apparatus 21 executes the read computer program. Consequently, a logical functional block for performing an operation to be performed by the iris recognition apparatus 2 is realized or implemented in the arithmetic apparatus 21. That is, the arithmetic apparatus 21 is allowed to function as a controller or realizing or implementing the logical functional block for performing an operation (in other words, a processing) to be performed by the iris recognition apparatus 2.

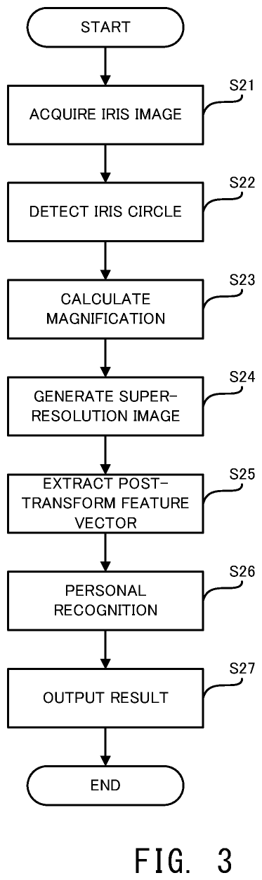

FIG. 2 illustrates an example of the logical functional block realized or implemented in the arithmetic apparatus 21 to perform an iris recognition operation. As illustrated in FIG. 2, an iris image acquisition unit 211 that is a specific example of the “iris image acquisition unit”, a calculation unit 212 that is a specific example of the “calculation unit”, a generation unit 213 that is a specific example of the “generation unit”, a post-transform feature vector extraction unit 214 that is a specific example of the “post-transform feature vector extraction unit”, and a recognition unit 215 that is a specific example of the “determination unit” and the “recognition unit”, are realized or implemented in the arithmetic apparatus 21. The calculation unit 212 may include an iris circle detection unit 2121 and a magnification calculation unit 2122. The details of operation of each of the iris image acquisition unit 211, the calculation unit 212, the generation unit 213, the post-transform feature vector extraction unit 214, and the recognition unit 215 will be described later with reference to FIG. 3. The arithmetic apparatus 21, however, may not include the recognition unit 215.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the iris recognition apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The storage apparatus 22 may store a super-resolution model SM, a feature vector generation model GM, and a registered feature vector CC. The storage apparatus 22, however, may not store at least one of the super-resolution model SM, the feature vector generation model GM, and the registered feature vector CC. The details of the super-resolution model SM, the feature vector generation model GM, and the registered feature vector CC will be described later.

The communication apparatus 23 is configured to communicate with an external apparatus of the iris recognition apparatus 2 through a communication network.

The input apparatus 24 is an apparatus that receives an input of information to the information processing apparatus 2 from an outside of the iris recognition apparatus 2. For example, the input apparatus 24 may include an operating apparatus (e.g., at least one of a keyboard, a mouse, and a touch panel) that is operable by an operator of the iris recognition apparatus 2. For example, the input apparatus 24 may include a reading apparatus that is configured to read information recorded as data on a recording medium that is externally attachable to the iris recognition apparatus 2.

The output apparatus 25 is an apparatus that outputs information to the outside of the iris recognition apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio. That is, the output apparatus may include an audio apparatus (a so-called speaker) that is configured to output audio. For example, the output apparatus 25 may output information onto a paper surface. That is, the output apparatus 25 may include a print apparatus (a so-called printer) that is configured to print desired information on the paper surface.

### 2-2: Iris Recognition Operation Performed by Recognition Apparatus 2

Next, with reference to FIG. 3, an iris recognition operation performed by the iris recognition apparatus 2 in the second example embodiment will be described. FIG. 3 is a flowchart illustrating a flow of the iris recognition operation performed by the iris recognition apparatus 2 in the second example embodiment. Described hereinafter is a case where the number of pixels of the iris area is smaller than the desired number of pixels, and the scale factor is magnification.

As illustrated in FIG. 3, the iris image acquisition unit 211 acquires the iris image including the iris of a living body (step S21).

The iris circle detection unit 2121 detects the iris circle from the iris image (step S22).

The iris circle detection unit 2121 may calculate a vector representing a center position and the radius of the iris circle from the inputted iris image. The iris circle detection unit 2121 may be configured by a recurrent neural network, for example. The recurrent neural network may include a plurality of convolutional layers and a plurality of activation layers, may extract a feature vector of the input image, and may convert the extracted feature vector into the vector representing the center position and the radius of the relevant area by using a linear layer. The iris image LI inputted to the iris circle detection unit 2121, and the vector outputted from the iris circle detection unit 2121 may be normalized. In a case where the iris circle detection unit 2121 is configured as a neural network, as long as it meets the requirements, it is possible to use a neural network of any structure. For example, a structure similar to those of a VGG and a ResNet (Residual neural network) or the like that are models learned with a large-scale image dataset, may be used as the structure of the neural network, but other structures may be also used. A normalization layer such as batch normalization may be used as an intermediate layer of the neural network. A ReLU (Rectified Linear Unit) is often used as the activation layer, but other activation functions may be also used. The iris circle detection unit 2121 may be an imaging processing mechanism that is not configured by the neural network.

The magnification calculation unit 2122 calculates the magnification for the iris image LI from the radius of the iris circle included in the iris image LI detected by the iris circle detection unit 2121 and the desired radius (step S23). The magnification may be a ratio between the radius of the iris circle included in the iris image LI and the radius of the iris circle of the desired size. Furthermore, the magnification may not be a simple ratio between the radius of the iris circle included in the iris image LI and the radius of the iris circle of the desired size, but may be, for example, a converted value of logarithm or power of the ratio. Even in the second example embodiment, as in the calculation unit 12 in the first example embodiment, the magnification calculation unit 2122 may calculate a scale factor of less than 1, as a parameter corresponding to the magnification, in addition to or instead of the magnification.

The iris circle detection unit 2121 may calculate a diameter of the iris circle from the inputted iris image. In this instance, the magnification calculation unit 2122 calculates the magnification for the iris image LI from the diameter of the iris circle included in the iris image LI detected by the iris circle detection unit 2121 and a desired diameter. The iris circle detection unit 2121 may calculate an area of the iris circle from the inputted iris image. In this instance, the magnification calculation unit 2122 calculates the magnification for the iris image LI from the area of the iris circle included in the iris image LI detected by the iris circle detection unit 2121 and a desired area.

The generation unit 213 generates the resolution-converted image RI that is a super-resolution image acquired by enhancing the resolution of the iris image LI, in accordance with the magnification (step S24). The generation unit 213 may use the magnification calculated by the magnification calculation unit 2122 as it is, or may use the magnification calculated by the magnification calculation unit 2122 after it is normalized. The generation unit 213 may generate the resolution-converted image RI that is a super-resolution image, by using the super-resolution model SM. The super-resolution model SM is a model constructed by machine learning, so as to output the resolution-converted image RI in response to the inputted iris image LI. A specific example of a method of constructing the super-resolution model SM will be described in detail in third and fourth example embodiments. Furthermore, a specific example of the constructed super-resolution model SM will be described in detail in fifth to seventh example embodiments.

The post-transform feature vector extraction unit 214 extracts the post-transform feature vector OC that is the feature vector of the resolution-converted image RI (step S25). The post-transform feature vector extraction unit 214 may extract the post-transform feature vector OC from the resolution-converted image RI, by using the feature vector generation model GM.

The feature vector generation model GM is a model capable of generating a feature vector of the iris image HI in a case where this corresponding iris image HI of resolution suitable for the recognition including the iris area with the desired number of pixels is inputted by the post-transform feature vector extraction unit 214. The feature vector generation model GM may be constructed by machine learning to output an appropriate feature vector for the iris recognition in a case where the iris image HI is inputted. Specifically, the feature vector generation model GM may be constructed by adjusting a learning parameter included in the feature vector generation model GM so as to reduce (preferably, minimize) a loss function that is set on the basis of errors of a plurality of feature quantities generated from the iris image HI of the same individual). The feature vector generation model GM may be constructed as a convolution neural network that generates the feature vector by a convolution processing, for example. The feature vector generation model GM may be a model capable of generating the feature vector with high accuracy, and may be another neural network that has performed learning.

The constructed feature vector generation model GM may receive inputted input data, and may generate the registered feature vector CC that is a feature vector of the input data. The generated registered feature vector CC may be registered in the storage apparatus 22.

The recognition unit 215 recognizes a person by using a score indicating a degree of similarity between the post-transform feature vector OC and the feature vector prepared in advance (step S26). Here, the recognition refers to at least one of identifying a person in question, and determining a person to be who claims to be. The recognition unit 215 may determine a person to be who claims to be when a matching score indicating the degree of similarity between the post-transform feature vector OC and the registered feature vector CC prepared in advance is greater than or equal to a threshold. The recognition unit 215 may calculate the matching score by using a degree of cosine similarity between the post-transform feature vector OC and the registered feature vector CC, for example. The recognition unit 215 may determine whether or not the feature quantities are similar to each other, by utilizing such a property that the feature quantities of data about the same individual are likely to be similar and are likely to be directed in the same direction; that is, the degree of cosine similarity is likely to be increased. Alternatively, the recognition unit 215 may calculate the matching score, by using a L1 distance, or a L2 distance function between the post-transform feature vector OC and the registered feature vector CC, or the like, for example. The recognition unit 215 may determine whether or not the feature quantities are similar to each other, by utilizing such a property that the feature quantities of the data about the same individual such as the L2 distance function and the L1 distance function, are likely to be close to each other in distance.

The output apparatus 25 outputs the magnification calculated by the magnification calculation unit 2122 and the resolution-converted image RI generated by the generation unit 213 to the outside of the iris recognition apparatus 2, together with a recognition result by the recognition unit 215 (step S27). An output from the output apparatus 25 may be confirmed by a person who is a recognition target, a manager, a security guard, or the like. The output apparatus may output an alert in a case where the magnification is greater than or equal to a predetermined value. In a case where the generation unit 213 enlarges an image at the magnification that is greater than or equal to the predetermined value, there is a possibility that recognition accuracy decreases; however, the manager, the security guard, or the like, may be able to pay attention to the corresponding recognition by means of the output apparatus 25 outputting the alert.

### 2-3: Technical Effect of Iris Recognition Apparatus 2

The iris recognition often requires the relatively high-resolution iris image HI with an iris radius of 100 pixels or more. On the other hand, even in the case of using the low-resolution image LI with an iris radius of less than 100 pixels, if a certain degree of accuracy can be achieved, then, it is possible to perform the recognition simultaneously with another biometric recognition, by using one relatively low-resolution camera.

The iris recognition apparatus 2 in the second example embodiment is allowed to transform even the inputted low-resolution iris image LI into the high-resolution resolution-converted image RI that is a super-resolution image, regardless of the resolution of the iris image L1, and is thus capable of performing the iris recognition with high accuracy. Therefore, by applying the iris recognition apparatus 2 in the second example embodiment, it is possible to realize the recognition that allows both another biometric recognition and the iris recognition, by using an image captured with a single, relatively inexpensive camera, for example.

In a case where the scale factor is less than or equal to 1, not a resolution conversion processing by the generation unit 213 in the second example embodiment, but a resolution conversion processing using general bilinear and bicubic, area average, nearest neighbor, or the like, may be performed.

### 3: Third Example Embodiment

Next, an iris recognition apparatus, an iris recognition method, and a recording medium according to a third example embodiment will be described. The following describes the iris recognition apparatus, the iris recognition method, and the recording medium according to the third example embodiment, by using an iris recognition apparatus 3 to which the iris recognition apparatus, the iris recognition method, and the recording medium according to the third example embodiment are applied.

### 3-1: Configuration of Iris Recognition Apparatus 3

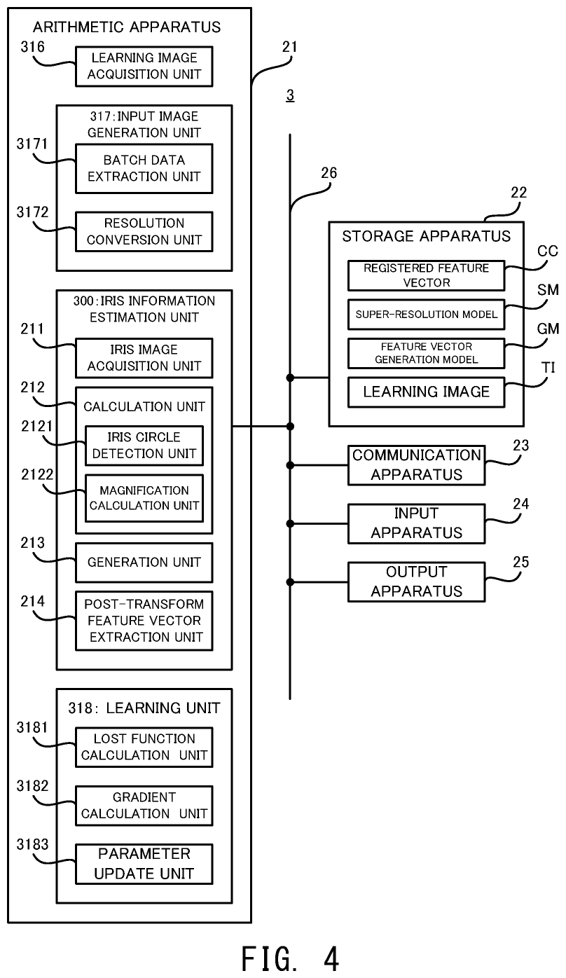

FIG. 4 is a block diagram illustrating a configuration of the iris recognition apparatus 3 in the third example embodiment. In the following description, the components already described carry the same reference numerals, and a detailed description thereof will be omitted.

As illustrated in FIG. 4, the iris recognition apparatus 3 includes the arithmetic apparatus and the storage apparatus 22. As illustrated in FIG. 4, a learning image acquisition unit 316 that is a specific example of the “learning image acquisition unit”; an input image generation unit that is a specific example of the “input image acquisition unit”; a learning unit 318 that is a specific example of the “learning unit”; and an iris information estimation unit 300 including the iris image acquisition unit 211, the calculation unit 212, the generation unit 213, and the post-transform feature vector extraction unit 214, are realized or implemented in the arithmetic apparatus 21. The input image generation unit 317 includes a batch data extraction unit 3171 and a resolution conversion unit 3172. The learning unit 318 includes a loss function calculation unit 3181, a gradient calculation unit 3182, and a parameter update unit 3183.

The storage apparatus 22 may store a learning image TI. The storage apparatus 22, however, may not store the learning image TI. In a case where the storage apparatus 22 does not store the learning image TI, the learning image TI may be acquired by the communication apparatus 23 from an external apparatus of the iris recognition apparatus 2, or the input apparatus may receive an input of the learning image TI from the outside of the iris recognition apparatus 2. The learning image TI may be an iris image including the iris area with the desired number of pixels.

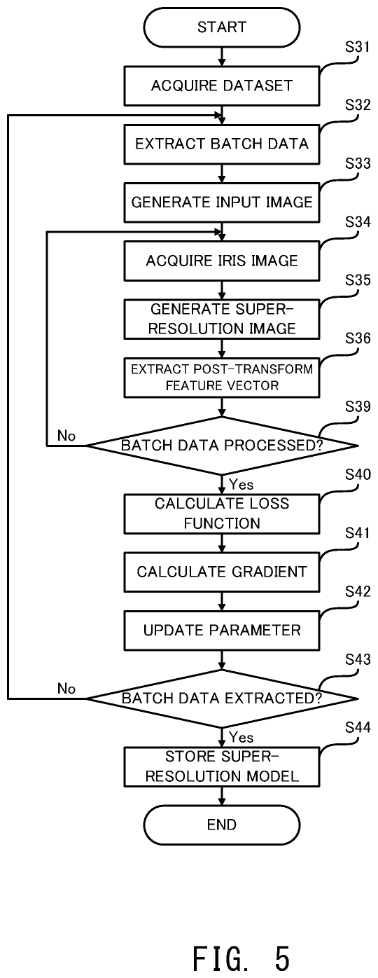

In the third example embodiment, the learning image acquisition unit 316, the input image generation unit 317, the learning unit 318, and the iris information estimation unit 300 construct the super-resolution model SM to be used by the generation unit 213, by performing machine learning using the learning image TI. The details of operation of each of the learning image acquisition unit 316, the input image generation unit 317, the learning unit 318, and the iris information estimation unit 300 will be described with reference to FIG. 5.

### 3-2: Learning Operation Performed by Iris Recognition Apparatus 3

Subsequently, with reference to FIG. 5, a learning operation performed by the iris recognition apparatus 3 in the third example embodiment will be described. FIG. 5 is a flowchart illustrating a flow of a learning operation performed by the iris recognition apparatus 3 in the third example embodiment.

As illustrated in FIG. 5, the learning image acquisition unit 316 acquires a dataset of the learning image TI including the iris area with the desired number of pixels, which is stored in the storage apparatus 22, for example (step S31). The learning image TI may be an image of the same resolution as that of the iris image HI suitable for the recognition by the iris recognition apparatus 3.

The batch data extraction unit 3171 randomly extracts a batch data of batch size, from the dataset of the learning image TI acquired by the learning image acquisition unit 316 (step S32). For example, in a case where the batch size is 32, the batch data extraction unit 3171 extracts 32 learning images TI. The batch size may use a value of 32, 64, 128, or the like. There is no particular limitation on the value of the batch size, and any value may be usable.

The resolution conversion unit 3172 generates an input image II in which the resolution of the learning image TI is converted in accordance with the inverse of an arbitrary magnification (step S33). That is, the resolution conversion unit 3172 generates a low-resolution input image II from a high-resolution learning image TI. The input image generation unit 317 is configured to prepare an image acquired by reducing the resolution of the learning image TI, as the input image II.

The resolution conversion unit 3172 may resize the learning image TI, thereby to generate the low-resolution input image II. The resolution conversion unit 3172 may resize the learning image TI, by thinning out the pixels of the learning image TI. That is, it is possible to generate the input image II acquired by reducing the resolution of the learning image TI due to the resizing the learning image TI by the resolution conversion unit 3172.

The resolution conversion unit 3172 may reduce the resolution of each learning image TI extracted by the batch data extraction unit 3171 by using the inverse of an arbitrary magnification selected in accordance with a uniform random number distribution, thereby to generate the input image II, for example. In this instance, the resolution conversion unit 3172 is allowed to generate the batch data uniformly including the input images II of various resolutions.

Alternatively, the resolution conversion unit 3172 may reduce the resolution of all the batch data of batch size, extracted by the batch data extraction unit 3171 at the same timing, by using the inverse of the same magnification, thereby to generate the input image II. At this time, the resolution conversion unit 3172 is allowed to generate the batch data including the input image II of the same resolution. In this instance, the resolution conversion unit 3172 may reduce the resolution of the batch data of batch size, extracted by the batch data extraction unit 3171 at different timing, by using the inverse of a different magnification, thereby to generate the input image II. The input image generation unit 317 may be configured to prepare the input image II such that the input images II of various resolutions are uniformly included in the entire dataset of the learning image TI acquired by the learning image acquisition unit 316.

The operation in the step S34, the step S35, and the step S36 may be the same as that in the step S21, step S24, and step S25 described with reference to FIG. 3. The data used for the operation in the second example embodiment, which are the iris image(s) LI for the recognition, are different from the data used for the operation in the third example embodiment, which are the input image(s) II prepared for the learning.

The iris image acquisition unit 211 acquires one input image II from the batch data of batch size (step S34). The generation unit 213 generates a resolution-converted input image RII in which the resolution of the input image II is converted by using the magnification used when the learning image TI is resized in the resolution conversion unit 3172 (step S35). Here, since the resolution conversion unit 3172 and the generation unit 213 perform resize and resolution conversion by using the same magnification, the resolution-converted input image RII has the same resolution as that of the learning image TI. The post-transform feature vector extraction unit 214 extracts an input feature vector OIC that is a feature vector of the resolution-converted input image RII (step S36). Furthermore, the post-transform feature vector extraction unit 214 may extract a learning feature vector TC that is a feature vector of the learning image TI. Alternatively, a set of the learning image TI and the learning feature vector TC that is the feature vector of the learning image TI may be stored in the storage apparatus 22 in advance.

The iris image acquisition unit 211 determines whether or not all the input images II in the batch data of batch size are already processed (step S39). When all the input images II in the batch data of batch size are not yet processed (the step S39: No), the processing proceeds to the step S34. That is, the iris information estimation unit 300 performs the operation in the step S34 to the step S38 on all the input images II in the batch data of batch size. In a case where an arithmetic operation is performed in a GPU or multithreading, the processing for each input image in the batch data of the batch size may be performed in parallel. The processing for each input image in part of the batch data of the batch size may be performed in parallel, and the processing for each input image in other part of the batch data of the batch size may be performed in series.

When all the input images II in the batch data of batch size are already processed (the step S39: Yes), the learning unit 318 allows the generation unit 213 to learn a method of generating the resolution-converted image RI. Specifically, the learning unit 318 allows the super-resolution model SM to be used by the generation unit 213, to learn the method of generating the resolution-converted image RI, thereby to construct the super-resolution model SM. More specifically, the learning unit 318 adjusts a learning parameter included in the super-resolution model SM. The learning unit 318 allows the generation unit 213 to learn the method of generating the resolution-converted image RI, on the basis of at least one of a first loss function in which a loss increases as the learning feature vector TC and the input feature vector OIC become less similar, and a second loss function in which the loss increases as the learning image TI and the resolution-converted input image RII become less similar. The learning unit 318 may optimize the iris information estimation unit 300 on the basis of the loss function.

First, the loss function calculation unit 3181 performs calculation using at least one of the first loss function in which the loss increases as the learning feature vector TC and the input feature vector OIC become less similar, and the second loss function in which the loss increases as the learning image TI and the resolution-converted input image RII become less similar (step S40).

The loss function calculation unit 3181 may input the learning feature vector TC that is a correct answer personal label and the input feature vector OIC of the resolution-converted input image RII extracted by the post-transform feature vector extraction unit 214, and may output a value of a first loss indicating a degree to which the learning feature vector TC and the input feature vector OIC are not similar. The loss function calculation unit 3181 may compare an one-hot vector generated from the learning feature vector TC that is the correct answer personal label, with a feature vector serving as the input feature vector OIC extracted by the post-transform feature vector extraction unit 214, by using a cross entropy loss function, thereby to acquire the first loss.

The loss function calculation unit 3181 may input the learning image TI that is a high-resolution image and the resolution-converted input image RII generated by the generation unit 213, and may output a value of a second loss indicating a degree to which the learning image TI and the resolution-converted input image RII are not similar. The loss function calculation unit may compare the learning image TI with the resolution-converted input image RII generated by the generation unit 213, by using the L1 distance loss function, thereby to acquire the second loss.

The loss function calculation unit 3181 may use not only the cross-entropy loss function and the L1 distance loss function, but also another loss function such as a KL divergence function and the L2 distance function, for example.

The loss function calculation unit 3181 may apply a weighting corresponding to the magnification calculated by the calculation unit 212, to the calculated loss. Generally, in many cases, the super-resolution processing with high magnification is harder than the super-resolution processing with low magnification. In other words, a recognition processing using the super-resolution image acquired by the super-resolution processing with the high magnification, is inferior in many cases in the recognition accuracy, to a recognition processing using the super-resolution image acquired by the super-resolution processing with the low magnification. Therefore, the loss function calculation unit 3181 may use the loss function that applies a large weight to the loss resulted from the super-resolution processing with the high magnification. That is, the learning unit 318 may allow the generation unit 213 to perform the learning, on the basis of a loss function in which the weight of the loss corresponding to the input image II generated by using a first magnification as an arbitrary magnification, is larger than the weight of the loss corresponding to the input image II generated by using a second magnification, which is lower than the first magnification, as the arbitrary magnification. The learning unit 318 may allow the generation unit 213 to perform the learning, on the basis of the first loss function, i.e., the loss function in which the weight of the loss corresponding to the resolution-converted input image RII generated by using the magnification, increases as the magnification is higher. In this way, a learning contribution increases in the super-resolution processing with the high magnification. Thus, the learning unit 318 is allowed to construct the super-resolution model SM in which a recognition performance hardly depends on the magnification.

The loss function calculation unit 3181 may apply the weighting corresponding to the magnification, separately to each of the first loss and the second loss. Alternatively, the loss function calculation unit 3181 may apply the weighting corresponding to the magnification, to each of the first loss and the second loss, and may sum up the results to output a single loss.

For example, in a case where the resolution conversion unit 3172 generates the batch data of batch size uniformly including the input images II of various resolutions, the loss function calculation unit 3181 may calculate the loss of the batch data of batch size, by applying a weighting corresponding to each of the various resolutions, to the loss of respective one of the input images II. The loss function calculation unit 3181 may calculate a mean value of weighting losses, and may output it as the loss of the batch data of batch size. Specifically, the resolution conversion unit 3172 may calculate the loss of the batch data of batch size, by applying a weighting corresponding to the magnification used in the step S33 to generate each input image II, to the loss of each input image II. As an example, in a case where the first magnification used to generate a first input image II is higher than the second magnification used to generate a second input image II, the resolution conversion unit 3172 may calculate the loss of the batch data of batch size, by applying the weighting corresponding to the magnification used in the step S33 to generate each input image II such that the weight for the loss of the first input image II is larger than the weight for the loss of the second input image II.

On the other hand, for example, in a case where the resolution conversion unit 3172 generates the batch data of batch size including the input images II of the same resolution, the loss function calculation unit 3181 may calculate the loss of the batch data of batch size, by applying the same weighting to the loss of each input image II. For example, the loss function calculation unit 3181 may calculate a loss mean value that is a mean value of the respective losses of the input images II. In this case, since the resolution is different for each of the batch data of batch size generated in the resolution conversion unit 3172 at different timing, the loss function calculation unit 3181 may apply a weighting corresponding to the resolution, to the loss mean value.

The gradient calculation unit 3182 calculates a gradient of the learned parameter included in the super-resolution model SM, by using an error back-propagation method using the value of the loss outputted by the loss function calculation unit 3181 (step S41). The parameter update unit 3183 updates a value of the learning parameter included in the super-resolution model SM, by using the calculated gradient of the learning parameters (step S42). The updating of the learning parameter in the stepped S42 corresponds to the learning of the super-resolution model SM. For example, the parameter update unit 3183 may optimize the value of the learning parameter so as to minimize a value of the loss function. An example of an optimization method used by the parameter update unit 3183 includes, but is not limited to, stochastic gradient descent or Adam, or the like. The parameter update unit 3183 may update the learning parameter by using a hyperparameter such as Weight decay and momentum, even when using the stochastic gradient descent.

The input image generation unit 317 determines whether or not the batch data are already extracted from a predetermined learning image TI (step S43). When the batch data are not yet extracted from the predetermined learning image TI (the step S43: No), the processing proceeds to the step S32. For example, in a case where the learning image acquisition unit 316 acquires a dataset of 320 learning images TI and the batch size is 32, the iris information estimation unit 300 may perform the operation in the step S32 to the step S42, ten times. When the batch data are already extracted from the predetermined learning image TI (step S43: Yes), the learning unit 318 stores, in the storage apparatus 22, the optimized super-resolution model SM including the optimally updated learning parameter (step S44).

### 3-3: Technical Effect of Iris Recognition Apparatus 3

The iris recognition apparatus 3 in the third example embodiment allows the generation unit 213 to learn the method of generating the resolution-converted image RI, on the basis of the loss function in which the loss increases as the learning image TI and the resolution-converted input image RII become less similar. It is therefore possible to increase the accuracy of the super-resolution processing.

Furthermore, the iris recognition apparatus 3 in the third example embodiment allows the generation unit 213 to learn the method of generating the resolution-converted image RI, on the basis of the loss function in which the loss increases as the learning feature vector TC and the input feature vector OIC become less similar. It is therefore possible to generate the resolution-converted image RI suitable for the iris recognition. That is, since the feature vector extracted from the image subjected to the super-resolution processing is used for the learning for the super-resolution processing, it is possible to construct the super-resolution model SM capable of generating the resolution-converted image RI from which the feature quantities suitable for the iris recognition may be extracted. The post-transform feature vector OC outputted by the iris information estimation unit 300 is a feature vector used to recognize a person. Thus, the resolution-converted image RI is preferably an image from which the post-transform feature vector OC appropriate for recognizing a person may be extracted. In other words, the resolution-converted image RI generated by the super-resolution model SM is an image subjected to the super-resolution processing with high accuracy, and is also an image suitable for matching.

Generally, the difficulty of the super-resolution processing varies depending on the magnification. Thus, the accuracy of the super-resolution processing may not be maintained if the loss function is uniformly calculated regardless of the magnification. That is, the accuracy of the super-resolution processing may be reduced in the case of the high magnification. In contrast, the iris recognition apparatus 3 in the third example embodiment uses the loss function to which a weight corresponding to the magnification is applied, and it is thus possible to maintain the accuracy of the super-resolution processing even when the magnification is changed. As an example, in a case where the first magnification used to generate the first input image II is higher than the second magnification used to generate the second input image II, the resolution conversion unit 3172 calculates the loss of the batch data of batch size, by applying the weighting corresponding to the magnification used in the step S33 to generate each input image II such that the weight for the loss of the first input image II is larger than the weight for the loss of the second input image II. Consequently, it is possible to construct the super-resolution model SM capable of generating the resolution-converted image RI that allows the accuracy of the iris recognition to be maintained even when the relatively low-resolution iris image LI is inputted. As a consequence, the generation unit 213 that uses the super-resolution model SM constructed by the iris recognition apparatus 3 in the third example embodiment, is allowed to realize the generation of the resolution-converted image RI of high resolution that is suitable for high-accuracy matching, regardless of the resolution of the iris image LI. That is, since the learning method for the super-resolution processing is devised in the iris recognition apparatus 3 in the third example embodiment, it is possible to maintain the accuracy of the iris recognition, even when the relatively low-resolution iris image LI in which the accuracy of matching tends to be low, is inputted.

Therefore, the iris recognition apparatus 3 in the third example embodiment is allowed to construct the super-resolution model SM in which the recognition performance hardly depends on the magnification. The iris recognition apparatus 3 in the third example embodiment is allowed to perform the super-resolution processing on the iris images corresponding to various magnification, while maintaining the recognition accuracy.

### 4: Fourth Example Embodiment

Next, an iris recognition apparatus, an iris recognition method, and a recording medium according to a fourth example embodiment will be described. The following describes the iris recognition apparatus, the iris recognition method, and the recording medium according to the fourth example embodiment, by using the iris recognition apparatus 3 to which the iris recognition apparatus, the iris recognition method, and the recording medium according to the fourth example embodiment are applied.

The iris recognition apparatus 3 in the fourth example embodiment may have the same configuration as that of the iris recognition apparatus 3 in the third example embodiment described above. The iris recognition apparatus 3 in the fourth example embodiment is different from the iris recognition apparatus 3 in the third example embodiment, in a processing of generating the input image II by the resolution conversion unit 3172, and a processing of calculating the loss function by the loss function calculation unit 3181. That is, the iris recognition apparatus 3 in the fourth example embodiment is different from the iris recognition apparatus 3 in the third example embodiment, in the operation in the step S33 and the operation in the step S40 illustrated in FIG. 5. Other features of the iris recognition apparatus 3 in the fourth example embodiment may be the same as those of the iris recognition apparatus 3 in the third example embodiment.

### 4-1: Learning Operation Performed by Iris Recognition Apparatus 3

In the fourth example embodiment, described is a case where the resolution conversion unit 3172 uses the first magnification and the second magnification, which is lower than the first magnification, as the arbitrary magnification. The resolution conversion unit 3172 generates a plurality of input images II such that a frequency of generating the input image II in accordance with the inverse of the first magnification is higher than a frequency of generating the input image II in accordance with the inverse of the second magnification (step S33). That is, the resolution conversion unit 3172 generates the plurality of input images II such that the number of the input images II generated increases as the magnification used is higher. Accordingly, the plurality of input images II generated by the resolution conversion unit 3172 includes more input images II generated by using the inverse of the high magnification. In other words, a frequency of selecting the magnification used by the resolution conversion unit 3172 is higher as the value of the magnification increases.

Generally, in many cases, as the magnification of the super-resolution processing is higher, it is harder to perform the super-resolution processing, in comparison with a case where the magnification of the super-resolution processing is low. Therefore, by increasing the number of times of learning the super-resolution processing as the magnification of the super-resolution processing is higher, it is expected to be possible to construct the super-resolution model SM that allows the super-resolution processing in which the accuracy is not inferior, even when the magnification of the super-resolution processing is high. That is, by preparing, as the input images II, a large number of low-resolution images that need to be subjected to the super-resolution processing by using the high magnification, it is expected to construct the super-resolution model SM that allows the super-resolution processing with high accuracy, regardless of the magnification.

For this reason, the resolution conversion unit 3172 may be configured such that as a value of the inverse of the magnification is smaller, it is more likely selected as a value used for a processing of reducing the resolution of the learning image TI. The resolution conversion unit may select the magnification to be used, in a probability distribution in which the input image II of lower resolution is more frequently generated. The resolution conversion unit 3172 may select the magnification to be used, in accordance with a weighted probability distribution. In order to increase the number of times of learning the super-resolution processing with the high magnification to be used, the resolution conversion unit 3172 may select the magnification to be used, in a probability distribution that facilitates the generation of the low-resolution image with the high magnification. That is, the resolution conversion unit 3172 may be configured such that the input image II of lower resolution is more frequently generated. Thus, in the super-resolution processing by the subsequent generation unit 213, a higher magnification is more frequently used. The probability distribution used by the resolution conversion unit 3172 to select the magnification, may be created specifically by using a linear function or a quadratic function or the like. The probability distribution to be used may be such that the low-resolution image with the higher magnification is more frequently selected, and there is no other limitation.

By devising the processing of generating the input image II by the resolution conversion unit 3172, it is possible to construct the super-resolution model SM capable of realizing the super-resolution processing in which the recognition performance does not strongly depend on the magnification.

The operation by the resolution conversion unit 3172 in the fourth example embodiment plays the same role as the calculation of the weighting by the loss function calculation unit 3181 in the third example embodiment. For this reason, in the fourth example embodiment, the loss function calculation unit 3181 may not need to weight the loss in the calculation of the loss. Therefore, in the fourth example embodiment, the loss function calculation unit 3181 may not apply the weighting corresponding to the magnification (step S40).

### 4-2: Technical Effect of Iris Recognition Apparatus 3

The iris recognition apparatus 3 in the fourth example embodiment constructs the super-resolution model SM by performing machine learning in which the weighting corresponding to the magnification is applied, in order to generate the resolution-converted image RI of high resolution that is suitable for high-accuracy matching, regardless of the resolution of the iris image LI. The generation unit 213 that uses the super-resolution model SM constructed by the iris recognition apparatus 3 in the fourth example embodiment, is allowed to realize the generation of the resolution-converted image RI of high resolution that is suitable for high-accuracy matching, regardless of the resolution of the iris image LI.

Furthermore, since the iris recognition apparatus 3 in the fourth example embodiment also allows the generation unit 213 to learn the method of generating the resolution-converted image RI on the basis of the loss function in which the loss increases as the learning image TI and the resolution-converted input image RII become less similar, it is possible to increase the accuracy of the super-resolution processing. In addition, since the iris recognition apparatus 3 in the fourth example embodiment also allows the generation unit 213 to learn the method of generating the resolution-converted image RI on the basis of the loss function in which the loss increases as the learning feature vector TC and the input feature vector OIC become less similar, it is possible to generate the resolution-converted image RI suitable for the iris recognition. Therefore, the iris recognition apparatus 3 in the fourth example embodiment is also allowed to construct the super-resolution model SM in which the recognition performance hardly depends on the magnification. The iris recognition apparatus 3 in the fourth example embodiment is allowed to perform the super-resolution processing on the iris images corresponding to various magnification, while maintaining the recognition accuracy.

The iris recognition apparatus 3 in the third example embodiment and the iris recognition apparatus 3 in the fourth example embodiment are effective in that they are allowed to realize the super-resolution processing with high accuracy, regardless of the magnification, thereby allowing the iris recognition with high accuracy regardless of the magnification of the super-resolution processing, but the iris recognition apparatus 3 in the third example embodiment is simpler than the iris recognition apparatus 3 in the fourth example embodiment, in a processing of constructing the super-resolution model SM. Furthermore, the iris recognition apparatus 3 in the fourth example embodiment weights a distribution of the resolution of the input image II and directly operates the input image II to be inputted, so that a contribution of the weighting to the construction processing is larger than that of the iris recognition apparatus 3 in the third example embodiment, and it is thus possible to further prevent that the accuracy is reduced by the magnification.

### 5: Fifth Example Embodiment

Next, an iris recognition apparatus, an iris recognition method, and a recording medium according to a fifth example embodiment will be described. The following describes the iris recognition apparatus, the iris recognition method, and the recording medium according to the fifth example embodiment, by using an iris recognition apparatus 5 to which the iris recognition apparatus, the iris recognition method, and the recording medium according to the fifth example embodiment are applied.

### 5-1: Configuration of Iris Recognition Apparatus 5

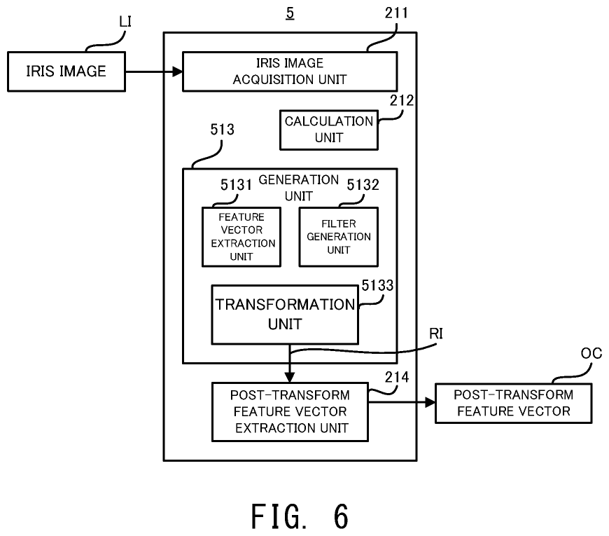

FIG. 6 is a block diagram illustrating a configuration of an iris recognition apparatus 5 in a fifth example embodiment. In the following description, the components already described carry the same reference numerals, and a detailed description thereof will be omitted. The iris recognition apparatus 5 includes the iris image acquisition unit 211, the calculation unit 212, a generation unit 513, and the post-transform feature vector extraction unit 214.

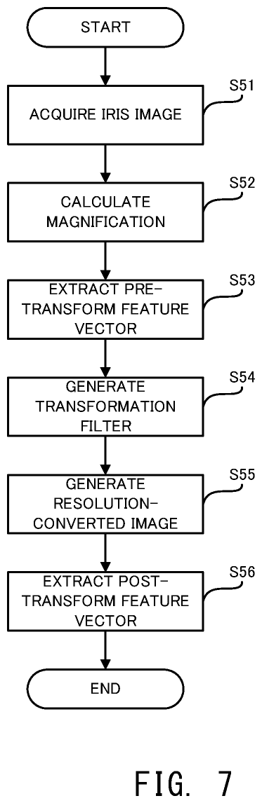

The generation unit 513 performs the super-resolution processing of generating the resolution-converted image RI in which the resolution of the iris image LI is transformed in accordance with the magnification, by using the super-resolution model SM. The generation unit includes a feature vector extraction unit 5131, a filter generation unit 5132, and a transformation unit 5133. The details of operation of each of the feature vector extraction unit 5131, the filter generation unit 5132, and the transformation unit 5133 will be described with reference to FIG. 7.

### 5-2: Super-Resolution Processing Performed by Generation Unit 513

Next, with reference to FIG. 7, the super-resolution processing performed by the iris recognition apparatus 5 in the fifth example embodiment will be described. FIG. 7 is a flowchart illustrating a flow of the super-resolution processing performed by the iris recognition apparatus 5 in the fifth example embodiment.

As illustrated in FIG. 7, the iris image acquisition unit 211 acquires the iris image LI including the iris of a living body (step S51). The calculation unit 212 calculates the magnification for the iris image LI (step S52).

The feature vector extraction unit 5131 extracts a pre-transform feature vector PC that is a feature vector of the iris image LI (step S53). The feature vector extraction unit 5131 may extract the pre-transform feature vector PC from the low-resolution iris image LI, by using a low-resolution feature vector extraction model included in the super-resolution model SM. The low-resolution feature vector extraction model may be a model capable of outputting a feature vector fitting for a filter processing described later in a case where the low-resolution iris image LI is inputted. The low-resolution feature vector extraction model may be constructed, for example, by machine learning, to output the feature vector fitting for the filter processing described later in a case where the iris image LI is inputted. The feature vector extraction unit 5131 may input the iris image LI to the low-resolution feature vector extraction model and may output the pre-transform feature vector PC.

The filter generation unit 5132 generates one or more transformation filters for transforming the pre-transform feature vector PC in accordance with the magnification calculated by the calculation unit 212 (step S54). The filter generation unit 5132 may generate one or more transformation filters corresponding to the magnification, by using a transformation filter generation model included in the super-resolution model SM. The transformation filter generation model may be a model capable of generating a transformation filter fitting for a filter processing described later in a case where the magnification is inputted. The transformation filter generation model may be configured, for example, by machine learning, to output the transformation filter fitting for the filter processing described later in a case where the magnification is inputted. The filter generation unit 5132 may input the magnification calculated by the calculation unit 212, to the transformation filter generation model, and may output one or more transformation filters.

The filter generation unit 5132 may generate a transformation filter for a convolution processing. The filter generation unit 5132 may generate a transformation filter with a size of 3×3, for example. The size of the transformation filter is not limited to 3×3, and may be 5×5. The size of the transformation filter may be arbitrarily determined in accordance with requirements such as a processing velocity and processing accuracy. Alternatively, the filter generation unit may determine the size of the transformation filter. The filter generation unit 5132 may generate (Cin×Cout) transformation filters, for example. Cin may be, for example, a number corresponding to the number of channels of the pre-transform feature vector PC. For example, Cin may be 3 in a case where the iris image LI is a color image, and may be 1 in a case where the iris image LI is a gray image. For example, Cout may be 3 in a case where the resolution-converted image RI outputted by the filter processing is a color image, and may be 1 in a case where the resolution-converted image RI outputted by the filter processing is a gray image.

The transformation filter generated by the filter generation unit 5132 may be used to enhance the resolution of the pre-transform feature vector PC extracted from the low-resolution iris image LI. The pre-transform feature vector PC extracted from the low-resolution iris image LI may have a size of (Cin×h×w), for example. More specifically, the feature vector extraction unit 5131 may generate Cin pre-transform feature quantities PC, each having a size of (h×w). The feature vector of resolution enhanced by using the transformation filter, may have a size of (Cout×H×W), for example. More specifically, Cout feature quantities, the resolution of which is enhanced and each of which has a size of (H×W), may be generated.

For example, the calculation unit 212 is assumed to calculate the magnification including a one-dimensional vector. In this case, the transformation filter generation model may receive an input of the magnification including the one-dimensional vector, and may output the transformation filter with a size of (Cin×Cout×3×3). More specifically, the transformation filter generation model may receive an input of the magnification including the one-dimensional vector, and may output Cin×Cout transformation filters, each having a size of (3×3). Alternatively, the transformation filter generation model may receive an input of the magnification including the one-dimensional vector, and may output Cin×Cout transformation filters, each having a size of (h×w).

The filter generation unit 5132 may generate a transformation filter other than the filter for the convolution processing. For example, the filter generation unit 5132 may generate a transformation filter with the same size as that of the feature vector extracted by the feature vector extraction unit 5131. The size of the feature vector may be (Cin×h×w), for example.

The transformation unit 5133 generates the resolution-converted image RI by transforming the pre-transform feature vector PC by the filter processing using one or more transformation filters (step S55). The transformation unit 5133 may perform the filter processing on the pre-transform feature vector PC, by using the transformation filter generated by the filter generation unit 5132. The transformation unit 5133 may transform the low-resolution iris image LI by using the transformation filter generated by the filter generation unit 5132, and may generate the resolution-converted image RI that is a super-resolution image of enhanced resolution.

The transformation unit 5133 may adjust a magnitude of the pre-transform feature vector PC in accordance with the magnification, before the filter processing. For example, in the case of a magnification of 2 times, the transformation unit 5133 may insert zero between the pixels of the pre-transform feature vector PC, and may increase the magnitude of the pre-transform feature vector PC by 2 times. For example, in the case of a magnification of 1.5 times, the transformation unit 5133 may insert zero between the pixels of the pre-transform feature vector PC, at intervals of two pixels, and may increase the magnitude of the pre-transform feature vector PC by 1.5 times. The transformation unit 5133 may insert a value other than zero between the pixels, and may increase the magnitude of the pre-transform feature vector PC. For example, the transformation unit 5133 may insert a value acquired by copying values of adjacent pixels, between the pixels, and may increase the magnitude of the pre-transform feature vector PC. The transformation unit may adjust the magnitude of the pre-transform feature vector PC, by using another method that is not limited to those examples. For example, the transformation unit 5133 may increase the magnitude of the pre-transform feature vector PC, by interpolation using nearest neighbor, linear interpolation, bilinear, bicubic, or the like.

The transformation unit 5133 may perform the convolution processing with a stride 1, on the interpolated feature vector, by using the transformation filter. Here, the stride refers to an interval of applying the convolution, and the convolution processing with the stride 1 refers to moving the transformation filters at one pixel interval and performing the convolution processing.

The transformation unit 5133 may perform the convolution processing by using a filter processing model included in the super-resolution model SM. The filter processing model may be a model capable of outputting the resolution-converted image RI by using the transformation filter in a case where the pre-transform feature vector PC is inputted. The filter processing model may be configured, for example, by machine learning, to output the resolution-converted image RI by using the transformation filter in a case where the pre-transform feature vector PC is inputted. The transformation unit 5133 may input the pre-transform feature vector PC to the filter processing model and may output the resolution-converted image RI. A convolutional layer realized by the filter processing model is not limited to one layer, but may be a plurality of layers. In this instance, an activation layer such as a ReLU function, may be inserted after each convolution layer.

The transformation unit 5133 may perform a filter processing other than the convolution processing. For example, the transformation unit 5133 may generate a filter feature vector with the same size as that of the pre-transform feature vector PC, and may output an element product of the pre-transform feature vector PC and the filter feature vector. In this case, the number of layers realized by the filter processing model is not limited to one, but may be plural. In addition, a plurality of layers in which these layers and the activation layer are combined, may be also used. The post-transform feature vector extraction unit 214 extracts the post-transform feature vector OC that is a feature vector of the resolution-converted image RI (step S56).

### 5-3: Technical Effect of Iris Recognition Apparatus 5

The iris recognition apparatus 5 in the fifth example embodiment estimates and generates the transformation filter for each magnification of the super-resolution processing. Therefore, a single super-resolution model SM makes it possible to perform the super-resolution processing corresponding to various magnification. The iris recognition apparatus 5 in the fifth example embodiment is particularly useful in a case where the resolution of the resolution-converted image RI is determined. That is, the super-resolution model SM used for the iris recognition apparatus in the fifth example embodiment is capable of outputting the resolution-converted image RI of the desired resolution, regardless of the resolution of the iris image LI. Therefore, by applying, to existing iris recognition mechanisms, the super-resolution model SM learned and constructed to output the resolution-converted image RI corresponding to each of the existing iris recognition mechanisms, the existing iris recognition mechanisms are allowed to perform the iris recognition even in a case where the iris image LI of any resolution is inputted thereto.

### 6: Sixth Example Embodiment

Next, an iris recognition apparatus, an iris recognition method, and a recording medium according to a sixth example embodiment will be described. The following describes the iris recognition apparatus, the iris recognition method, and the recording medium according to the sixth example embodiment, by using an iris recognition apparatus 6 to which the iris recognition apparatus, the iris recognition method, and the recording medium according to the sixth example embodiment are applied.

### 6-1: Configuration of Iris Recognition Apparatus 6

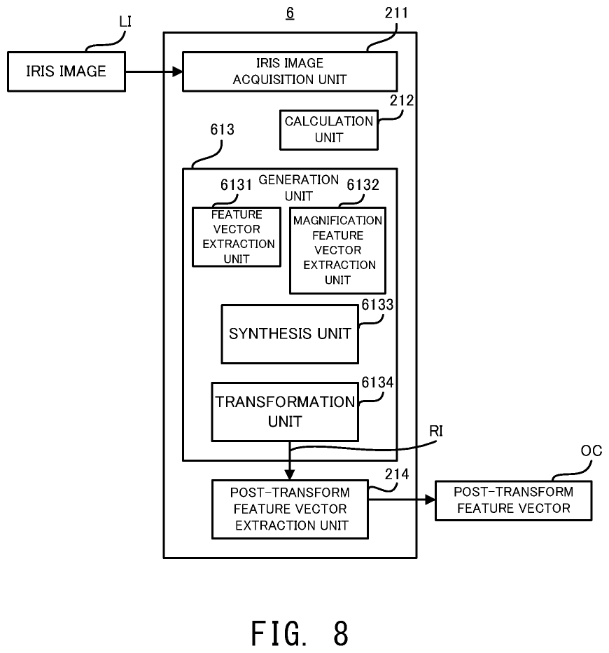

FIG. 8 is a block diagram illustrating a configuration of an iris recognition apparatus 6 in the sixth example embodiment. In the following description, the components already described carry the same reference numerals, and a detailed description thereof will be omitted. The iris recognition apparatus 6 includes the iris image acquisition unit 211, the calculation unit 212, a generation unit 613, and the post-transform feature vector extraction unit 214.

The generation unit 613 performs the super-resolution processing of generating the resolution-converted image RI in which the resolution of the iris image LI is transformed in accordance with the magnification, by using the super-resolution model SM. The generation unit includes a feature vector extraction unit 6131, a magnification feature vector extraction unit 6132, a synthesis unit 6133, and a transformation unit 6134. The generation unit 613 may not include the transformation unit 6134

### 6-2: Super-Resolution Processing Performed by Generation Unit 613

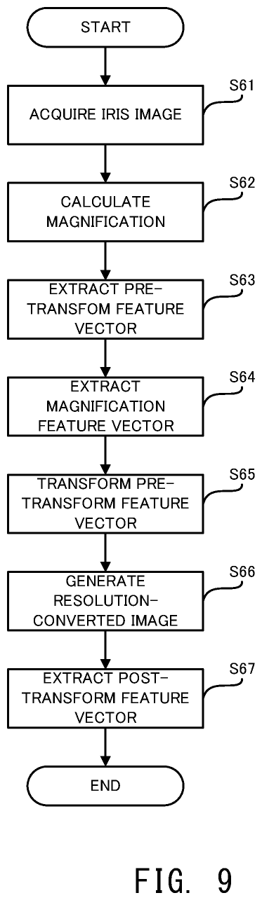

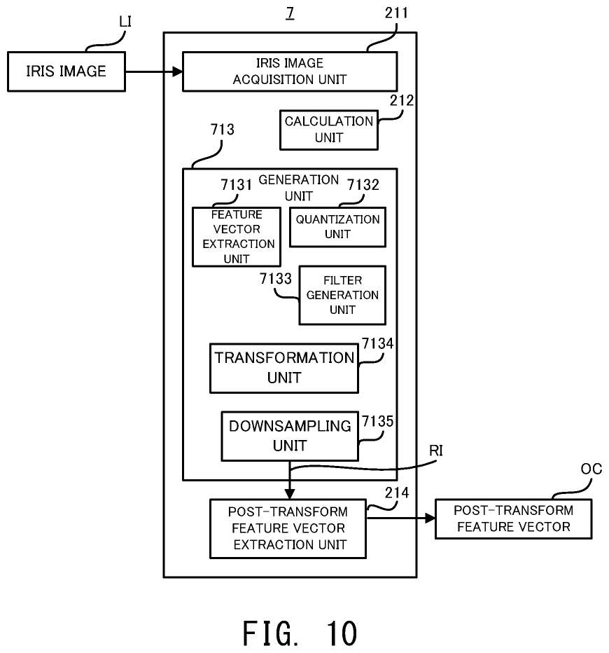

Next, with reference to FIG. 9, the super-resolution processing performed by the iris recognition apparatus 6 in the sixth example embodiment will be described. FIG. 9 is a flowchart illustrating a flow of the super-resolution processing performed by the iris recognition apparatus 6 in the sixth example embodiment.

As illustrated in FIG. 9, the iris image acquisition unit 211 acquires the iris image including the iris of a living body (step S61). The calculation unit 212 calculates the magnification for the iris image (step S62).

The feature vector extraction unit 6131 extracts the pre-transform feature vector PC that is the feature vector of the iris image LI (step S63). The feature vector extraction unit 6131 may extract the pre-transform feature vector PC from the low-resolution iris image LI, by using the low-resolution feature vector extraction model included in the super-resolution model SM. The low-resolution feature vector extraction model may be a model capable of generating a feature vector fitting for at least one of a feature vector synthesis processing described later and the filter processing in a case where the low-resolution iris image LI is inputted. The low-resolution feature vector extraction model may be constructed, for example, by machine learning, to output the feature vector fitting for at least one of the feature vector synthesis processing described later and the filter processing in a case where the iris image LI is inputted. The feature vector extraction unit 6131 may input the iris image LI to the low-resolution feature vector extraction model and may output the pre-transform feature vector PC.

The magnification feature vector extraction unit 6132 extracts a magnification feature vector RC that is a feature vector of the magnification (step S64). The magnification feature vector extraction unit 6132 may generate a magnification feature vector map that is a feature vector of the magnification. The magnification feature vector extraction unit 6132 may extract the magnification feature vector RC, by using a magnification feature vector extraction model included in the super-resolution model SM. The magnification feature vector extraction model may be constructed to output the magnification feature vector RC fitting for at least one of the feature vector synthesis processing described later and the filter processing om a case where the magnification is inputted. The magnification feature vector extraction unit 6132 may input the magnification to the magnification feature vector extraction model and may output the magnification feature vector RC. The magnification feature vector extraction unit 6132 may extract the magnification feature vector RC with the same size as that of the pre-transform feature vector PC.

The synthesis unit 6133 synthesizes the pre-transform feature vector PC and the magnification feature vector RC, and may transform the pre-transform feature vector PC (step S65). The synthesis unit 6133 may synthesize the pre-transform feature vector PC and the magnification feature vector RC, and may generate a synthesis feature vector. The synthesis unit may transform, by synthesis, the pre-transform feature vector PC to a feature vector that does not depend on the magnification. The synthesis unit 6133 may perform any one of combination, element sum, and element product. The synthesis unit 6133 may synthesize the magnification feature vector map and a feature vector map of the iris image LI. In this instance, the magnification feature vector map generated by the magnification feature vector extraction unit may have a size of (Cf×h×w). Cf may be the same number as the number of channels of the pre-transform feature vector PC, for example. The synthesis unit 6133 may combine the magnification feature vector map and the feature vector map of the iris image LI by using channels, thereby to provide a synthesis feature vector map as the synthesis feature vector.

The transformation unit 6134 generates the resolution-converted image RI (step S66). The transformation unit 6134 may generate the resolution-converted image RI by using the filter processing model included in the super-resolution model SM. The filter processing model may be a model capable of outputting a resolution-converted image RI by using the transformation filter in a case where the pre-transform feature vector PC (the synthesis feature vector) that is transformed, is inputted. The filter processing model may be configured, for example, by machine learning, to output the resolution-converted image RI by using the transformation filter in a case where the pre-transform feature vector PC (the synthesis feature vector) that is transformed, is inputted. The transformation filter may be a filter that does not depend on the magnification, and may be used regardless of the number of pixels of the iris image LI. The transformation unit 6134 may input the pre-transform feature vector PC (the synthesis feature vector) that is transformed, to the filter processing model and may output the resolution-converted image RI. The transformation unit 6134 may output the resolution-converted image RI by performing the convolution processing on the synthesis feature vector. The transformation unit may perform the convolution processing by using a single convolution layer. Alternatively, the number of convolution layers may be plural, and the transformation unit 6134 may perform the convolution processing by using a plurality of layers in which the convolution layers and the activation layer are combined.

The generation unit 613 may not include the independent transformation unit 6134. The synthesis unit 6133 may synthesize the pre-transform feature vector PC and the magnification feature vector RC, may transform the pre-transform feature vector PC, and may perform the convolution processing on the pre-transform feature vector PC that is transformed, thereby to generate the resolution-converted image RI. The synthesis unit 6133 may generate the resolution-converted image RI by using the filter processing model described above.

The post-transform feature vector extraction unit 214 extracts the post-transform feature vector OC that is the feature vector of the resolution-converted image RI (step S67).

### 6-3: Technical Effect of Iris Recognition Apparatus 6

The iris recognition apparatus 6 in the sixth example embodiment is allowed to perform the super-resolution processing corresponding to various magnification by using a single super-resolution model SM, by synthesizing the pre-transform feature vector PC and the magnification feature vector RC. According to the iris recognition apparatus 6 in the sixth example embodiment, since the magnification feature vector extraction unit 6132 is configured to extract the magnification feature vector RC corresponding to the magnification, it is possible to generate the resolution-converted image RI by using a common transformation filter that does not depend on the magnification. The iris recognition apparatus 6 in the sixth example embodiment is particularly useful in a case where the resolution of the resolution-converted image RI is determined. That is, as in the iris recognition apparatus 5 in the fifth example embodiment, the super-resolution model SM used for the iris recognition apparatus 6 in the sixth example embodiment is capable of outputting the resolution-converted image RI of the desired resolution, regardless of the resolution of the iris image LI. Therefore, by applying, to the existing iris recognition mechanisms, the super-resolution model SM learned and constructed to output the resolution-converted image RI corresponding to each of the existing iris recognition mechanisms, the existing iris recognition mechanisms are allowed to perform the iris recognition with high accuracy even in a case where the iris image LI of any resolution is inputted thereto.

### 7: Seventh Example Embodiment

Next, an iris recognition apparatus, an iris recognition method, and a recording medium according to a seventh example embodiment will be described. The following describes the iris recognition apparatus, the iris recognition method, and the recording medium according to the seventh example embodiment, by using an iris recognition apparatus 7 to which the iris recognition apparatus, the iris recognition method, and the recording medium according to the seventh example embodiment are applied.

### 7-1: Configuration of Iris Recognition Apparatus 7

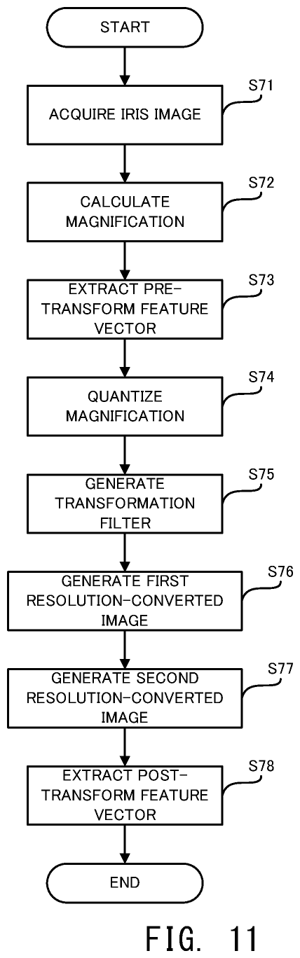

FIG. 10 is a block diagram illustrating a configuration of an iris recognition apparatus 7 in a seventh example embodiment. In the following description, the components already described carry the same reference numerals, and a detailed description thereof will be omitted. The iris recognition apparatus 7 includes the iris image acquisition unit 211, the calculation unit 212, a generation unit 713, and the post-transform feature vector extraction unit 214.

The generation unit 713 performs the super-resolution processing of generating the resolution-converted image RI in which the resolution of the iris image LI is transformed in accordance with the magnification, by using the super-resolution model SM. The generation unit includes a feature vector extraction unit 7131, a quantization unit 7132, a filter generation unit 7133, a transformation unit 7134, and a downsampling unit 7135.

The iris recognition apparatus 7 in the seventh example embodiment is different from the iris recognition apparatus 5 in the fifth example embodiment in that it includes the quantization unit 7132 before the filter generation unit 7133 and includes the downsampling unit 7135 after the transformation unit 7134.

### 7-2: Super-Resolution Processing Performed by Generation Unit 713

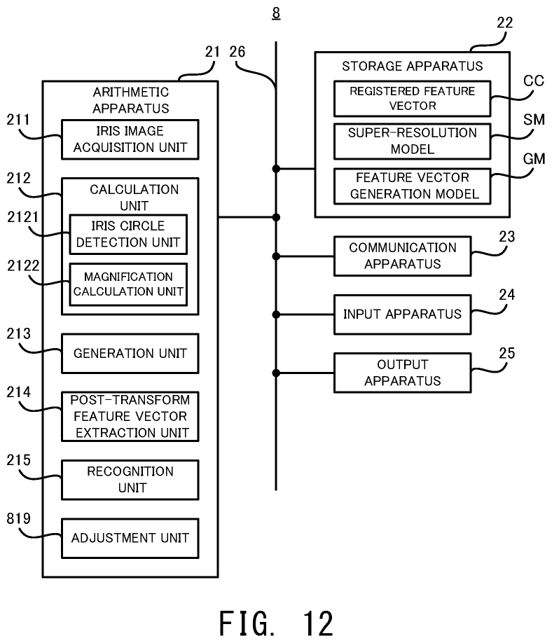

Next, the super-resolution processing performed by the iris recognition apparatus 7 in the seventh example embodiment will be described with reference to FIG. 11. FIG. 11 is a flowchart illustrating a flow of super-resolution processing performed by the iris recognition apparatus 7 in the seventh example embodiment.

As illustrated in FIG. 11, the iris image acquisition unit 211 acquires the iris image LI including the iris of a living body (step S71). The calculation unit 212 calculates the magnification for the iris image LI (step S72).

The feature vector extraction unit 7131 extracts the pre-transform feature vector PC that is the feature vector of the iris image LI (step S73). The feature vector extraction unit 7131 may extract the pre-transform feature vector PC from the low-resolution iris image LI, by using the low-resolution feature vector extraction model included in the super-resolution model SM. The low-resolution feature vector extraction model may be a model capable of outputting a feature vector fitting for a filter processing described later in a case where the low-resolution iris image LI is inputted. The low-resolution feature vector extraction model may be constructed, for example, by machine learning, to output the feature vector fitting for the filter processing described later in a case where the iris image LI is inputted. The feature vector extraction unit 7131 may input the iris image LI to the low-resolution feature vector extraction model and may output the pre-transform feature vector PC.

The quantization unit 7132 quantizes the magnification to a predetermined magnification (step S74). The quantization unit 7132 may quantize the inputted magnification to a value that is a power of 2, such as 2, 4, and 8. In this case, for example, when a magnification of 1.5 times is inputted, the quantization unit 7132 may output a magnification of 2 times. Specifically, the quantization unit 7132 may search for n that satisfies 2ⁿ⁻¹<R<2ⁿ for magnification R, and may output 2ⁿ as a quantization magnification. Note that the predetermined magnification may not be a power of 2, and may take a value that is an arbitrary power such as a power of 1.5 and a power of 2.5. The predetermined magnification may not be a value represented by the power, and may take another discrete value such as a multiple of 2.

The filter generation unit 7133 generates one or more transformation filters for transforming the pre-transform feature vector PC in accordance with the quantized magnification (step S75). The filter generation unit 7133 in the seventh example embodiment is different in that the magnification of the discrete value is inputted, from the filter generation unit 5132 in the fifth example embodiment to which the magnification of a continuous value may be inputted. The filter generation unit 7133 may generate one or more transformation filters corresponding to the magnification, by using the transformation filter generation model included in the super-resolution model SM. The transformation filter generation model may be a model capable of generating a transformation filter fitting for a filter processing described later in a case where the quantized magnification is inputted. The transformation filter generation model may be configured, for example, by machine learning, to output the transformation filter fitting for the filter processing described later in a case where the quantized magnification is inputted. The filter generation unit 7133 may input the magnification quantized by the quantization unit 7132 to the transformation filter generation model and may output one or more transformation filters.

The filter generation unit 7133 does not generate the transformation filters corresponding to various magnification, but generates the transformation filter corresponding to the quantized magnification. That is, the transformation filter generation model is constructed by learning the generation of the transformation filter that is specific to the limited magnification. As described above, since the transformation filter generation model in the seventh example embodiment is constructed by the learning that is specific to the limited magnification, it is possible to realize the super-resolution processing with hither accuracy, by using the transformation filter generated by the filter generation unit 7133 using the transformation filter generation model.

The transformation unit 7134 generates a first resolution-converted image by transforming the pre-transform feature vector PC by the filter processing using one or more transformation filters (step S76). The transformation unit 7134 may adjust the magnitude of the pre-transform feature vector PC in accordance with the magnification, before the filter processing. The transformation unit 7134 may perform the convolution processing with the stride 1, on the interpolated feature vector, by using the transformation filter. The transformation unit 7134 may generate the first resolution-converted image by using the filter processing model included in the super-resolution model SM. The filter processing model may be a model capable of outputting the first resolution-converted image by using the transformation filter in a case where the pre-transform feature vector PC is inputted. The filter processing model may be configured, for example, by machine learning, to output the first resolution-converted image by using the transformation filter r in a case where the pre-transform feature vector PC is inputted. The transformation unit 7134 may input the pre-transform feature vector PC to the filter processing model and may output the first resolution-converted image. The convolutional layer realized by the filter processing model is not limited to one layer, but may be a plurality of layers. In this instance, the activation layer such as a ReLU function, may be inserted after each convolution layer.

The downsampling unit 7135 downsamples the number of pixels of the first resolution-converted image, and generates a second resolution-converted image in which the number of pixels of the iris area is the same as the desired number of pixels (step S77). For example, in a case where the magnification is 1.5 times and the quantized magnification is 2 times, the downsampling unit 7135 may downsample the number of pixels from the first resolution-converted image subjected to the super-resolution processing twice as much as the iris image LI, to the second resolution-converted image with the number of pixels that is 1.5 times that of the iris image LI. The downsampling unit 7135 may perform the downsampling by a general thinning processing or the like.

The post-transform feature vector extraction unit 214 extracts the post-transform feature vector OC that is the feature vector of the resolution-converted image RI (step S78).

### 7-3: Technical Effect of Iris Recognition Apparatus 7

The iris recognition apparatus 7 in the seventh example embodiment estimates and generates the transformation filter corresponding to the magnification acquired by quantizing the magnification of the super-resolution processing. Therefore, a single super-resolution model SM makes it possible to perform the super-resolution processing corresponding to various magnification. The iris recognition apparatus 7 in the seventh example embodiment is allowed to realize a successive magnification with high accuracy, by upsampling the number of pixels by 2, 4, and 8 times, and further performing the downsampling from the size, by using the transformation filter corresponding to the magnification. The iris recognition apparatus 7 in the seventh example embodiment is particularly useful in a case where the resolution of the resolution-converted image RI is determined. That is, as in the iris recognition apparatuses 5 and 6 in the fifth and sixth example embodiments, the super-resolution model SM used for the iris recognition apparatus 7 in the seventh example embodiment, is capable of outputting the resolution-converted image RI of the desired resolution, regardless of the resolution of the iris image LI. Therefore, by applying, to the existing iris recognition mechanisms, the super-resolution model SM learned and constructed to output the resolution-converted image RI corresponding to each of the existing iris recognition mechanisms, the existing iris recognition mechanisms are allowed to perform the iris recognition with high accuracy even in a case where the iris image LI of any resolution is inputted thereto.

### 8: Eighth Example Embodiment

Next, an iris recognition apparatus, an iris recognition method, and a recording medium according to an eighth example embodiment will be described. The following describes the iris recognition apparatus, the iris recognition method, and the recording medium according to the eighth example embodiment, by using an iris recognition apparatus 8 to which the iris recognition apparatus, the iris recognition method, and the recording medium according to the eighth example embodiment are applied.

### 8-1: Configuration of Iris Recognition Apparatus 8

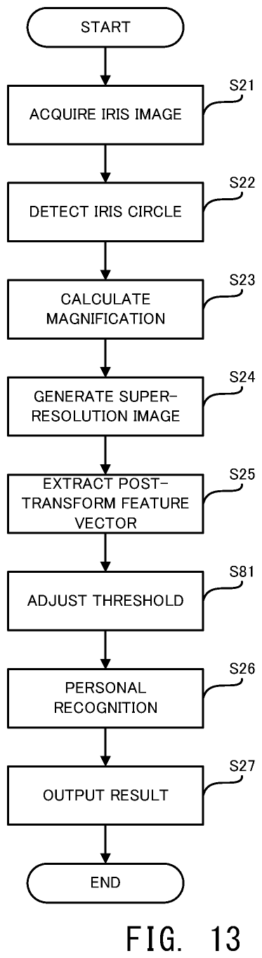

FIG. 12 is a block diagram illustrating a configuration of an iris recognition apparatus 8 in an eighth example embodiment. In the following description, the components already described carry the same reference numerals, and a detailed description thereof will be omitted. The iris recognition apparatus 8 includes the iris image acquisition unit 211, the calculation unit 212, the generation unit 213, the post-transform feature vector extraction unit 214, the recognition unit 215, and an adjustment unit 819.

### 8-2: Iris Recognition Operation Performed by Iris Recognition Apparatus 8

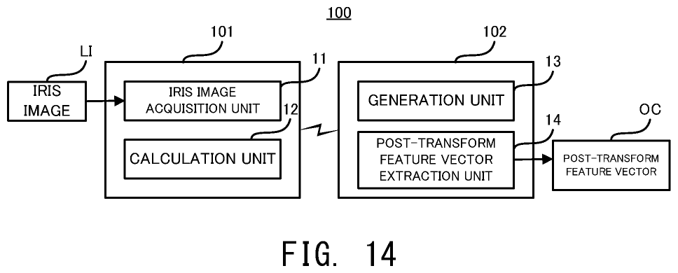

Next, with reference to FIG. 13, the super-resolution processing performed by the iris recognition apparatus 8 in the eighth example embodiment will be described. FIG. 13 is a flowchart illustrating a flow of super-resolution processing performed by the iris recognition apparatus 8 in the eighth example embodiment.

As illustrated in FIG. 13, even in the eighth example embodiment, as in the second example embodiment, the iris recognition apparatus 8 performs the operation from the step S21 to the step S27. In the eighth example embodiment, before the recognition operation by the recognition unit 215 in the step S26, the adjustment unit 819 adjusts a threshold used by the recognition unit 215 for the recognition, in accordance with the magnification (step S81). That is, in the eighth example embodiment, the difficulty that the recognition unit 215 recognizes a person by is adjusted in accordance with the magnification.

The recognition unit 215 recognizes the person in question when the matching score indicating the degree of similarity between the post-transform feature vector extracted by the post-transform feature vector extraction unit 214 and the registered feature vector prepared in advance is greater than or equal to the threshold adjusted by the adjustment unit 819 (step S26).

### 8-3: Technical Effect of Iris Recognition Apparatus 8

In the iris recognition using the iris image subjected to the super-resolution processing, it is sometimes preferable to change the probability of the recognition due to the magnitude of the magnification of the super-resolution processing. In the iris recognition apparatus 8 in the eighth example embodiment, since the threshold used by the recognition unit 215 for the recognition can be adjusted in accordance with the magnification, it is possible to adjust the difficulty of recognizing a person by adjusting the threshold used for the recognition, even when it is preferable to change the probability of the recognition due to the magnitude of the magnification.

### 9: Ninth Example Embodiment

Next, an iris recognition apparatus, an iris recognition system, an iris recognition method, and a recording medium according to a ninth example embodiment will be described. The following describes the iris recognition apparatus, the iris recognition method, and the recording medium according to the ninth example embodiment, by using an iris recognition system 100 to which the iris recognition apparatus, the iris recognition system, the iris recognition method, and the recording medium according to the ninth example embodiment are applied.

### 9-1: Configuration of Iris Recognition System 100

FIG. 14 is a block diagram illustrating a configuration of the iris recognition system 100 in the ninth example embodiment. In the following description, the components already described carry the same reference numerals, and a detailed description thereof will be omitted. As illustrated in FIG. 14, the iris recognition 100 includes a first apparatus 101 and a second apparatus 102. The first apparatus 101 includes the iris image acquisition unit 11 and the calculation unit 12. The second apparatus 102 includes the generation unit 13 and the post-transform feature vector extraction unit 14.

That is, the iris image acquisition unit 11 that is a specific example of the “iris image acquisition unit”, the calculation unit 12 that is a specific example of the “calculation unit”, the generation unit 13 that is a specific example of the “generation unit”, and the post-transform feature vector extraction unit 14 that is a specific example of the “post-transform feature vector extraction unit” may be provided in different apparatus. For example, the first apparatus 101 may include only the iris image acquisition unit 11, and the second apparatus 102 may include the calculation unit 12, the generation unit 13, and the post-transform feature vector extraction unit 14. Alternatively, the iris image acquisition unit 11, the calculation unit 12, the generation unit 13, and the post-transform feature vector extraction unit 14 may be provided in the first apparatus 101 and the second apparatus 102 in another combination.

The first apparatus 101 and the second apparatus 102 are configured to communicate with each other, and each of them is configured to transmit and receive a processing result from the other. As illustrated in FIG. 14, described is a case where the first apparatus 101 includes the iris image acquisition unit 11 and the calculation unit 12, and the second apparatus 102 includes the generation unit 13 and the post-transform feature vector extraction unit 14. In this instance, the first apparatus 10 is configured to transmit a calculation result of the calculation unit 12 to the second apparatus 102, and the second apparatus 102 is configured to receive the calculation result, and the generation unit 13 is configured to generate the resolution-converted image in which the resolution of the iris image is transformed in accordance with the calculation result. Furthermore, the iris recognition system may include three or more apparatuses, and the iris image acquisition unit 11, the calculation unit 12, the generation unit 13, and the post-transform feature vector extraction unit 14 may be provided in each of the apparatus in any combination.

In the above-described example embodiments, the iris image is exemplified, but this super-resolution technique/technology may be applied to another imaging processing field such as face recognition. Furthermore, although the second and subsequent example embodiments describe a case where the scale factor is a magnification of 1 time or more, the scale factor is not limited to 1 or more but may be less than 1.

In addition, although the iris recognition apparatuses in the above example embodiments determine the scale factor from the number of pixels of the iris area included in the iris image, the scale factor may be determined regardless of the number of pixels of the iris area. For example, the scale factor used by the iris recognition apparatus for the resolution conversion, may be determined in accordance with a distance between an imaging apparatus and a living body when the iris image is captured. The scale factor used by the iris recognition apparatus may be the scale factor that allows appropriate resolution conversion.

### 10: Supplementary Notes

With respect to the example embodiment described above, the following Supplementary Notes are further disclosed.

### [Supplementary Note 1]

An iris recognition apparatus comprising:
an iris image acquisition unit that acquires an iris image including an iris of a living body;
a calculation unit that calculates a scale factor for the iris image, from a size of an iris area included in the iris image and from a desired size;
a generation unit that generates a resolution-converted image in which resolution of the iris image is converted in accordance with the scale factor; and
a post-transform feature vector extraction unit that extracts a post-transform feature vector that is a feature vector of the resolution-converted image.

### [Supplementary Note 2]

The iris recognition apparatus according to supplementary note 1, wherein
the size of the iris area is smaller than the desired size,
the scale factor is magnification,
the generation unit generates, as the resolution-converted image, a super-resolution image in which the resolution of the iris image is enhanced, in accordance with the magnification.

### [Supplementary Note 3]

The iris recognition apparatus according to supplementary note 1 or 2, further comprising: a learning image acquisition unit that acquires a learning image including the iris area of the desired size; and an input image generation unit that generates an input image in which resolution of the learning image is converted in accordance with an inverse of an arbitrary scale factor, wherein the generation unit generates a resolution-converted input image of the same resolution as that of the learning image in which resolution of the input image is converted in accordance with the arbitrary scale factor, and the iris recognition apparatus further comprises a learning unit that allows the generation unit to learn a method of generating the resolution-converted image, on the basis of a loss function in which a loss increases as the learning image and the resolution-converted input image become less similar.

### [Supplementary Note 4]

The iris recognition apparatus according to any one of supplementary notes 1 to 3, further comprising:
a learning image acquisition unit that acquires a learning image including the iris area of the desired size; and
an input image generation unit that generates an input image in which resolution of the learning image is converted in accordance with an inverse of an arbitrary scale factor, wherein
the generation unit generates a resolution-converted input image of the same resolution as that of the learning image in which resolution of the input image is converted in accordance with the arbitrary scale factor,
the post-transform feature vector extraction unit extracts a learning feature vector that is a feature vector of the learning image and an input feature vector that is a feature vector of the resolution-converted input image, and
the iris recognition apparatus further comprises a learning unit that allows the generation unit to learn a method of generating the resolution-converted image, on the basis of a loss function in which a loss increases as the learning feature vector and the input feature vector become less similar.

### [Supplementary Note 5]

The iris recognition apparatus according to supplementary note 3 or 4, wherein the learning unit allows the generation unit to perform learning, on the basis of a loss function in which a weight of the loss corresponding to the input image generated by using a first scale factor as the arbitrary scale factor, is larger than a weight of the loss corresponding to the input image generated by using a second scale factor, which is smaller than the first scale factor, as the arbitrary scale factor.

### [Supplementary Note 6]

The iris recognition apparatus according to any one of supplementary notes 3 to 5, wherein the input image generation unit generates a plurality of input images such that a frequency of generating the input image by using a first scale factor as the arbitrary scale factor, is higher than a frequency of generating the input image by using a second scale factor, which is smaller than the first scale factor, as the arbitrary scale factor.

### [Supplementary Note 7]

The iris recognition apparatus according to any one of claims 1 to 6, wherein the generation unit includes:
a pre-transform feature vector extraction unit that extracts a pre-transform feature vector that is a feature vector of the iris image;
a filter generation unit that generates one or more transformation filters for transforming the pre-transform feature vector, in accordance with the scale factor; and
a transformation unit that generates the resolution-converted image by transforming the pre-transform feature vector by one or more filter processings using the one or more transformation filters.

### [Supplementary Note 8]

The iris recognition apparatus according to any one of supplementary notes 1 to 7, wherein the generation unit includes:
a pre-transform feature vector extraction unit that extracts a pre-transform feature vector that is a feature vector of the iris image;
a scale factor feature vector extraction unit that extracts a scale factor feature vector that is a feature vector of the scale factor; and
a transformation unit that generates the resolution-converted image by synthesizing the pre-transform feature vector and the scale factor feature vector and transforming the pre-transform feature vector.

### [Supplementary Note 9]

The iris recognition apparatus according to any one of supplementary notes 1 to 8, wherein the generation unit includes:
a pre-transform feature vector extraction unit that extracts a pre-transform feature vector that is a feature vector of the iris image;
a quantization unit that quantizes the scale factor to a predetermined scale factor;
a filter generation unit that generates one or more transformation filters for transforming the pre-transform feature vector, in accordance with the quantized scale factor;
a transformation unit that generates a first resolution-converted image by transforming the pre-transform feature vector by one or more filter processings using the one or more transformation filters; and
a downsampling unit that downsamples number of pixels of the first resolution-converted image and generates a second resolution-converted image in which the size of the iris area is the same as the desired size.

### [Supplementary Note 10]

The tris recognition apparatus according to any one of supplementary notes 1 to 9, further comprising:
a determination unit that determines a person to be who claims to be when a matching score indicating a degree of similarity between the post-transform feature vector extracted by the post-transform feature vector extraction unit and a feature vector prepared in advance, is greater than or equal to a threshold; and
an adjustment unit that adjusts the threshold in accordance with the scale factor.

### [Supplementary Note 11]

The iris recognition apparatus according to any one of supplementary notes 1 to 10, further comprising:
a recognition unit that performs recognition by using a score indicating a degree of similarity between the post-transform feature vector and a feature vector prepared in advance; and
an output unit that outputs a recognition result of the recognition unit, the scale factor, and the resolution-converted image to an outside of the iris recognition apparatus, and outputs an alert in a case where the scale factor is greater than or equal to a predetermined value.

### [Supplementary Note 12]

An iris recognition system including:
an iris image acquisition unit that acquires an iris image including an iris of a living body;
a calculation unit that calculates a scale factor for the iris image, from a size of an iris area included in the iris image and from a desired size;
a generation unit that generates a resolution-converted image in which resolution of the iris image is converted in accordance with the scale factor; and
a post-transform feature vector extraction unit that extracts a post-transform feature vector that is a feature vector of the resolution-converted image.

### [Supplementary Note 13]

An iris recognition method including:
acquiring an iris image including an iris of a living body;
calculating a scale factor for the iris image, from a size of an iris area included in the iris image and from a desired size;
generating a resolution-converted image in which resolution of the iris image is converted in accordance with the scale factor; and
extracting a post-transform feature vector that is a feature vector of the resolution-converted image.

### [Supplementary Note 14]

A recording medium on which a computer program that allows a computer to execute an iris recognition method is recorded, the iris recognition method including:
acquiring an iris image including an iris of a living body;
calculating a scale factor for the iris image, from a size of an iris area included in the iris image and from a desired size;
generating a resolution-converted image in which resolution of the iris image is converted in accordance with the scale factor; and
extracting a post-transform feature vector that is a feature vector of the resolution-converted image.

At least a part of the constituent components of each of the example embodiments described above may be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is allowed to be changed, if desired, without departing from the essence or spirit of this disclosure which can be read from the claims and the entire identification. An iris recognition apparatus, an iris recognition system, an iris recognition method, and a recording medium with such changes are also intended to be within the technical scope of this disclosure.

### DESCRIPTION OF REFERENCE CODES

1, 2, 3, 5, 6, 7, 8 Iris recognition apparatus
11, 211 Iris image acquisition unit
12, 212 Calculation unit
11, 211 Iris circle detection unit
2122 Magnification calculation unit
13, 213, 513, 613, 713 Generation unit
14, 214 Post-transform feature vector extraction unit
215 Recognition unit
21 Arithmetic apparatus
22 Storage apparatus
300 Iris information estimation unit
316 Learning image acquisition unit
317 Input image generation unit
3171 Batch data extraction unit
3172 Resolution conversion unit
318 Learning unit
3181 Loss function calculation unit
3182 Gradient calculation unit
31183 Parameter update unit
5131, 6131, 7131 Feature vector extraction unit
5132, 7133 Filter generation unit
5133, 6134, 7134 Transformation unit
6132 Magnification feature vector extraction unit
6133 Synthesis unit
7132 Quantization unit
7135 Downsampling unit
819 Adjustment unit
100 Iris recognition system
SM Super-resolution model
GM Feature vector generation model
L1, HI Iris image
RI Resolution-converted image
PC Pre-transform feature vector
OC Post-transform feature vector
TI Learning image
TC Learning feature vector
II Input image
RII Resolution-converted input image
OIC input feature vector
RC magnification feature vector
CC Registered feature vector

1. An iris recognition apparatus comprising:
at least one memory that is configured to store instructions; and
at least one processor that is configured to execute the instructions to:
acquire an iris image including an iris of a living body;
calculate a scale factor for the iris image, from a size of an iris area included in the iris image and from a desired size;
generate a resolution-converted image in which resolution of the iris image is converted in accordance with the scale factor; and
extract a post-transform feature vector that is a feature vector of the resolution-converted image.

2. The iris recognition apparatus according to claim 1,
wherein
the size of the iris area is smaller than the desired size,
the scale factor is magnification,
the at least one processor is configured to execute the instructions to generate, as the resolution-converted image, a super-resolution image in which the resolution of the iris image is enhanced, in accordance with the magnification.

3. The iris recognition apparatus according to claim 1, wherein the at least one processor is configured to execute the instructions to:
acquire a learning image including the iris area of the desired size; and
generate an input image in which resolution of the learning image is converted in accordance with an inverse of an arbitrary scale factor, wherein
generate a resolution-converted input image of the same resolution as that of the learning image in which resolution of the input image is converted in accordance with the arbitrary scale factor; and
allow learning of a method of generating the resolution-converted image, on the basis of a loss function in which a loss increases as the learning image and the resolution-converted input image become less similar.

4. The iris recognition apparatus according to claim 1, wherein the at least one processor is configured to execute the instructions to:
acquire a learning image including the iris area of the desired size;
generate an input image in which resolution of the learning image is converted in accordance with an inverse of an arbitrary scale factor;
generate a resolution-converted input image of the same resolution as that of the learning image in which resolution of the input image is converted in accordance with the arbitrary scale factor;
extract a learning feature vector that is a feature vector of the learning image and an input feature vector that is a feature vector of the resolution-converted input image; and
allow learning of a method of generating the resolution-converted image, on the basis of a loss function in which a loss increases as the learning feature vector and the input feature vector become less similar.

5. The iris recognition apparatus according to claim 3, wherein the at least one processor is configured to execute the instructions to perform learning, on the basis of a loss function in which a weight of the loss corresponding to the input image generated by using a first scale factor as the arbitrary scale factor, is larger than a weight of the loss corresponding to the input image generated by using a second scale factor, which is smaller than the first scale factor, as the arbitrary scale factor.

6. The iris recognition apparatus according to claim 3, wherein the at least one processor is configured to execute the instructions to generates a plurality of input images such that a frequency of generating the input image by using a first scale factor as the arbitrary scale factor, is higher than a frequency of generating the input image by using a second scale factor, which is smaller than the first scale factor, as the arbitrary scale factor.

7. The iris recognition apparatus according to claim 1, wherein
the at least one processor is configured to execute the instructions to:
extract a pre-transform feature vector that is a feature vector of the iris image;
generate one or more transformation filters for transforming the pre-transform feature vector, in accordance with the scale factor; and
generate the resolution-converted image by transforming the pre-transform feature vector by one or more filter processings using the one or more transformation filters.

8. The iris recognition apparatus according to claim 1, wherein
the at least one processor is configured to execute the instructions to:
extract a pre-transform feature vector that is a feature vector of the iris image;
extract a scale factor feature vector that is a feature vector of the scale factor; and
generate the resolution-converted image by synthesizing the pre-transform feature vector and the scale factor feature vector and transforming the pre-transform feature vector.

9. The iris recognition apparatus according to claim 1, wherein
the at least one processor is configured to execute the instructions to:
extract a pre-transform feature vector that is a feature vector of the iris image;
quantize the scale factor to a predetermined scale factor;
generate one or more transformation filters for transforming the pre-transform feature vector, in accordance with the quantized scale factor;
generate a first resolution-converted image by transforming the pre-transform feature vector by one or more filter processings using the one or more transformation filters; and
downsample number of pixels of the first resolution-converted image and generates a second resolution-converted image in which the size of the iris area is the same as the desired size.

10. The tris recognition apparatus according to claim 1, wherein the at least one processor is configured to execute the instructions to:
determine a person to be who claims to be when a matching score indicating a degree of similarity between the post-transform feature vector extracted by the post-transform feature vector extraction unit and a feature vector prepared in advance, is greater than or equal to a threshold; and
adjust the threshold in accordance with the scale factor.

11. The iris recognition apparatus according to claim 1, wherein the at least one processor is configured to execute the instructions to:
perform recognition by using a score indicating a degree of similarity between the post-transform feature vector and a feature vector prepared in advance; and
output a recognition result, the scale factor, and the resolution-converted image to an outside of the iris recognition apparatus, and outputs an alert in a case where the scale factor is greater than or equal to a predetermined value.

12. An iris recognition system comprising:
at least one memory that is configured to store instructions; and
at least one processor that is configured to execute the instructions to:
acquire an iris image including an iris of a living body;
calculate a scale factor for the iris image, from a size of an iris area included in the iris image and from a desired size;
generate a resolution-converted image in which resolution of the iris image is converted in accordance with the scale factor; and
extract a post-transform feature vector that is a feature vector of the resolution-converted image.

13. An iris recognition method comprising:
acquiring an iris image including an iris of a living body;
calculating a scale factor for the iris image, from a size of an iris area included in the iris image and from a desired size;
generating a resolution-converted image in which resolution of the iris image is converted in accordance with the scale factor; and
extracting a post-transform feature vector that is a feature vector of the resolution-converted image.

14. (canceled)
